(19) United States
(12) Patent Application Publication
(10) Pub. No.: US 2006/0238821 A1
(43) Pub. Date: Oct. 26, 2006

(54) Method and apparatus for communication among facsimile machines over digitally compressed audio channels and discrimination of call type

(75) Inventor: Reginald Alan Ratcliff, Norcross, GA (US)

Correspondence Address: SUGHRUE MION, PLLC, 2100 PENNSYLVANIA AVENUE, N.W., SUITE 800, WASHINGTON, DC, 20037, US

(73) Assignee: VIASAT, INC., Carlsbad, CA (US)

(21) Appl. No.: 11/407,283

(22) Filed: Apr. 20, 2006

Related U.S. Application Data
(60) Provisional application No. 60/673,722, filed on Apr. 21, 2005.
(60) Provisional application No. 60/673,632, filed on Apr. 21, 2005.

(51) Int. Cl. H04N 1/00

(52) U.S. Cl. 358/400; 358/442

(57) ABSTRACT

A method compatible with the multiple fax and data modem protocols to determine if a session originating terminal is a fax terminal or a data terminal without user intervention while allowing data terminals to operate at the highest possible speed. Further, there is a method of providing improved internetworking of fax machines over links that include relay technology.

### CROSS-REFERENCE TO RELATED APPLICATION

This application claims benefit of Provisional Application Nos. 60/673,722 and 60/673,632, each having a filing date of Apr. 21, 2005; the disclosure of each application is incorporated herein by reference in their entirety.

### BACKGROUND OF THE INVENTION

Telephony traffic commonly involves three major types of users: voice/audio; facsimile (fax) modems (terminals); and data modems (terminals). The telephony channel may use audio compression in order to achieve certain desired throughput and efficiency. However, where the telephony channel with audio compression is used to transport fax and data signals, as is often the case, problems are encountered with respect to communication failures due to management signaling delays or incorrect discrimination of the call type. In particular, the transport of facsimile (also referred to as telematic or fax) signals or data modem signals over digitally compressed audio channels is often done via a process commonly referred to as “relay” or “bypass.” In this process the modulated fax or data signal is de-modulated, transported as data, and then re-modulated at the receiving end. The transport may involve significant delay due to several reasons, including de-modulation and re-modulation delays as well as path latency, especially if the path includes a satellite link. Moreover, relay must be activated only when fax or data signals are present, and the proper type of relay (fax or data) must be selected.

For fax communication the commonly-used International Telecommunications Union (ITU) recommendations can be interpreted so that the maximum round-trip transmission delay accommodated between two fax terminals is as low as 270 ms. Fax terminals that implement such interpretations of the ITU recommendations often cannot internetwork with other fax terminals over satellite or compressed channels. Even fax terminals with less severe interpretations of the ITU recommendations often fail to internetwork with other terminals over channels with high latency or channels using relay technology.

The problems that arise when this type of delay is encountered require a technique that greatly increases the chance of two fax terminals internetworking via compressed or high-latency channels.

For fax or data communications over a path that also carries voice, proper discrimination of the audio signals as voice, fax, or data must occur so that the appropriate relay technology can be used. A common method of discrimination is to examine the “answer” tone of the terminating data or fax terminal. However newer fax terminals may have an answer tone indistinguishable from those of data terminals. Also, in a relay environment the originating terminal will be internetworking with a companion “proxy” terminal in the relay system, and not the actual terminating terminal. The proxy terminal and the communications link between the originating terminal and the companion proxy terminal may have characteristics different from the terminating terminal and communications link between the terminating terminal and the originating terminal. If the originating terminal receives signals directly from the terminating terminal before the relay operation is established it may make incorrect assumptions about the link and terminal with which it will actually be working.

Problems arise when operating a link that can carry voice, fax, and data signals, and on which these signals may change between any of the three types of signals at any time, and which uses relay technology. The solutions to these problems require a technique that can reliably discriminate among these types of signals and isolate originating and terminating terminals when appropriate.

According to ITU standard T.30 for fax transmission over voice channels (www.itu.org), an initial step involves the establishment of a voice call by an originating fax device. In doing so, the originating fax device dials a destination number and the destination fax device picks up the call, thereby establishing a voice call. Alternatively, users may first establish a voice call, conduct a conversation, and then agree to activate their fax devices. Next, the transition from the voice transmission to a fax transmission requires one party to signal that it is a fax device. Notably, either device can send its signal first.

There are at least two methods specified in the T.30 standard that may be used. First, the calling fax device can send to the called fax device a signal in the form of a Calling Tone (CNG). The CNG identifies the calling device as a fax machine. The CNG is a repeating 1100-Hz tone that is on for 0.5 seconds and then off for 3 seconds. Second, the called device can send to the calling device a signal in the form of a Called Station Identifier (CED) tone, which identifies the called device as a fax machine. CED is a 2100-Hz tone that is on for 2.6 to 4 seconds. Notably for the call discrimination problem, the CED tone is identical to the “Answer” tone used by some types of data terminals. However that fact does not impact the current fax relay problem.

Once either or both of these signals have been sent and received, the facilities and capabilities of the link are identified. A predetermined sequence of events is used to identify such facilities and capabilities for fax transmission. First, the called device will send to the calling device a Digital Information Signal (DIS), which describes the called fax machine's reception facilities. Such facilities may include maximum page length, scan line time, image resolution, and error correction mode. The ITU T.30 specification specifies the standard facilities that are contained in the DIS message. Second, the calling device then examines and analyzes the DIS message. Based on the result of that analysis, the calling device sends a Digital Command Signal (DCS) to the called device, which identifies for the called device the particular facilities that should be selected for the reception of the fax transmission.

There also are several optional, i.e., useful but not essential, signals that may be sent by the called device to the calling device. One optional signal is a Called Subscriber Identification (CSI) signal that provides additional detail as to the identity of the called device. Another optional signal is a Non-Standard Facilities (NSF) signal that informs the calling device that the called device may have some extra features that can be utilized during the fax transmission. Yet another optional signal that the calling device may send is a Transmitting Subscriber Identification (TSI) signal. Also, in response to an NSF message, the calling device can send a Non-Standard facilities Setup (NSS) signal that selects further reception parameters on the called device.

Additional signals may be sent that relate to verification of the communication path through a training exchange and the establishment of an agreed modulation speed. The fax devices then begin a start of the transmission of T.4 page data using HS modulation.

In connection with the use of ITU standard T.30 messages to establish and control communications, the fax devices send T.30 message in simplex mode-i.e. they are sent in only one direction at a time and are often of a format that is conventionally referred to in the art as “command and response.” One problem addressed by the present invention involves the constraints placed upon receipt of a response after issuance of a command. As mentioned earlier, this constraint can be interpreted to be as little as 270 ms, which is less than the transversal time via a satellite link and sometimes less than the transversal time of long terrestrial links. The T.30 protocol also specifies the manner and number of times that each command is to be re-sent if no response is received. The present invention uses T.30 queuing to address the command-response time constraint. T.30 queuing takes advantage of the T.30 recommendation for re-sending a message by intercepting and storing the responding fax terminal's response to the first command and sending it immediately upon receipt of the repeated command. This allows nearly all latency of the transmission channel to be removed. However, this is not enough for some fax terminals due to additional latency that exists in conventional components of the transmission channel. Previous implementations of the relay system also modified the T.30 NSF (Non Standard Features) message in order to prevent the fax terminals from entering into proprietary transmission modes, which may not be understood by the relay system. Although this message is optional, it was often sent by the problematic terminals. The present invention also uses deletion of the NSF frame by removing the command form of this message during the relay process. This allows the response to be shorter, thereby satisfying terminals that place a time constraint upon full receipt of the response, rather than upon the start of the reception of the response, thereby allowing the protocol to proceed.

In addition, where either or both data and fax relay systems are implemented, some fax and data initiation protocols provide insufficient information to determine if the answering modem is a fax or data terminal, and failure to select the correct relay method will result in failure of the fax or data transmission.

Relay systems that work over communication channels with significant delay or data rates lower than 64 kbps must also take steps to ensure that data modems with rate negotiation capabilities will operate at the maximum rate allowed by the modems, the relay system, and the communication channel. The ViaSat® Skylinx® data relay system has included a sequential called/caller link establishment method and prompt CM response since 1998, which allows several brands of data modem to operate at their maximum speed.

The problems that arise require a method to determine if the calling terminal is a fax terminal or a data terminal without user intervention and before the CM message must be provided while allowing data terminals to operate at the highest possible speed.

### SUMMARY OF THE INVENTION

According to a first aspect of the invention, improved internetworking for fax terminals is provided for all types of communication channels, including those that do not use digital compression or involve significant path delay. According to a feature of this first aspect of the invention, some internetworking messages are held by a communication terminal and selectively forwarded based on knowledge of the operation of the underlying protocol. According to another feature of the first aspect of the invention, certain protocol messages are suppressed to enable improved internetworking.

According to a second aspect of the invention, the relay system offers improved discrimination between fax and data communications sessions and permits a proper response to the original ANSam signal in a majority of instances. The relay system will listen for a T.30 CNG tone from the calling terminal, and if such a tone is detected it can either: not respond to the ANSam signal and allow the answering terminal to continue with fallback answer signals; or respond with a CM message indicating that a fax terminal is the calling modem. The choice is determined by considering the capabilities of the relay system and the communication link. If the CNG tone is not detected before the CM message is required the relay system will respond with a CM message indicating that the calling terminal is a data modem. For data or fax session that starts with ambiguous signals other than the ANSam signal at the called terminal, the relay system blocks passage of the starting signal until a signal that allows discrimination, such as the V.21 channel 2 HDLC flags of T.30, is detected. If the T.30 signal is not detected, the relay system will assume the session is a data session. The type of answer tone detected also determines if an echo canceller, if present, is enabled or disabled according to ITU-T recommendation G 165. The present invention permits operation with many types of calls, including calls that start as voice but then change to data or fax, and possibly even back to voice.

When this discrimination method and, if a data call is detected, sequential establishment of relay-modem sessions at the called side and then the calling side are used together then data and fax relay operation can take place at the maximum rates allowed by the terminals.

### BRIEF DESCRIPTION OF THE DRAWINGS

FIG. 1 is a block diagram of the environment of the invention.

FIG. 2 is a block diagram of a communication terminal employed in an illustrative implementation of the subject invention.

FIG. 3 is a time-line showing the failing operation of a facsimile protocol over a long delay link.

FIG. 4 is a time-line showing the successful operation of a facsimile protocol over a long delay link using one embodiment of the subject invention.

FIG. 5 is a time-line showing the successful operation of a facsimile protocol over a long delay link using another embodiment of the subject invention.

FIG. 6 is a flowchart of plural procedures used by terminals in the relay system to discriminate among voice, fax, and data calls.

### DESCRIPTION OF THE PREFERRED EMBODIMENTS

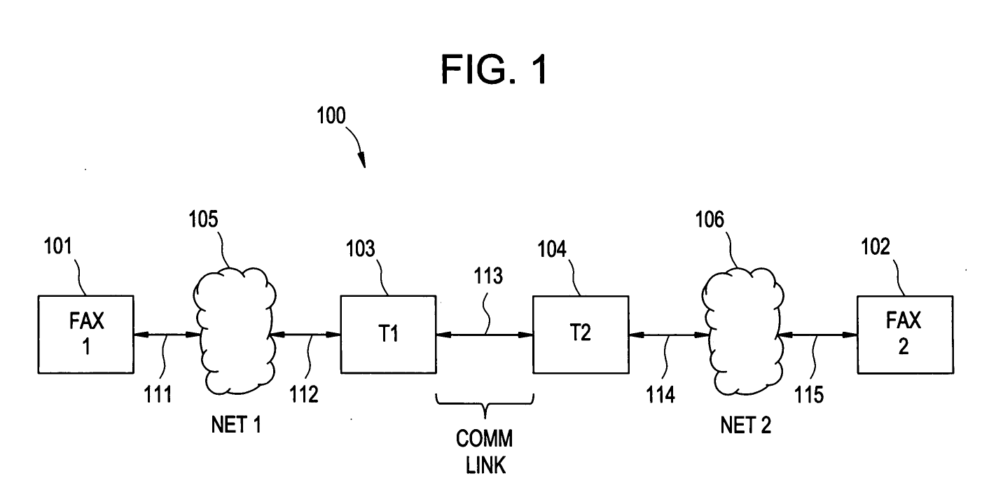

In FIG. 1, a block diagram of an exemplary implementation of a system 100 that may implement the subject invention is presented. A first user terminal 101which is illustrated as a terminal USER 1, communicates with a second user terminal 102, which is illustrated as a terminal USER 2, through the use of a bi-directional communications link that is established, respectively, by a first communications terminal 103 (T1) and a second communications terminal 104 (T2). USER 1 and USER 2 can be connected directly to their communication terminals, or, as shown in FIG. 1, through links 111, 112 to a first optional network 105 (NET1) and through links 114 and 115 to a second optional network 106 (NET2). Each user terminal may be any type of telephony network terminal such as a subscriber telephone set, a fax terminal, or a data modem, or any combination thereof. The first communications terminal 103 (T1) and second communication terminal 104 (T2) typically do not have any knowledge regarding the nature of USER 1 and USER 2. USER 1 and USER 2 are often different devices for each call or communications session.

In an exemplary embodiment of the invention, a satellite communication network as the communication link 113, where T1 and T2 are satellite terminals, and public switched telephone networks may be examples of NET1 and NET2.

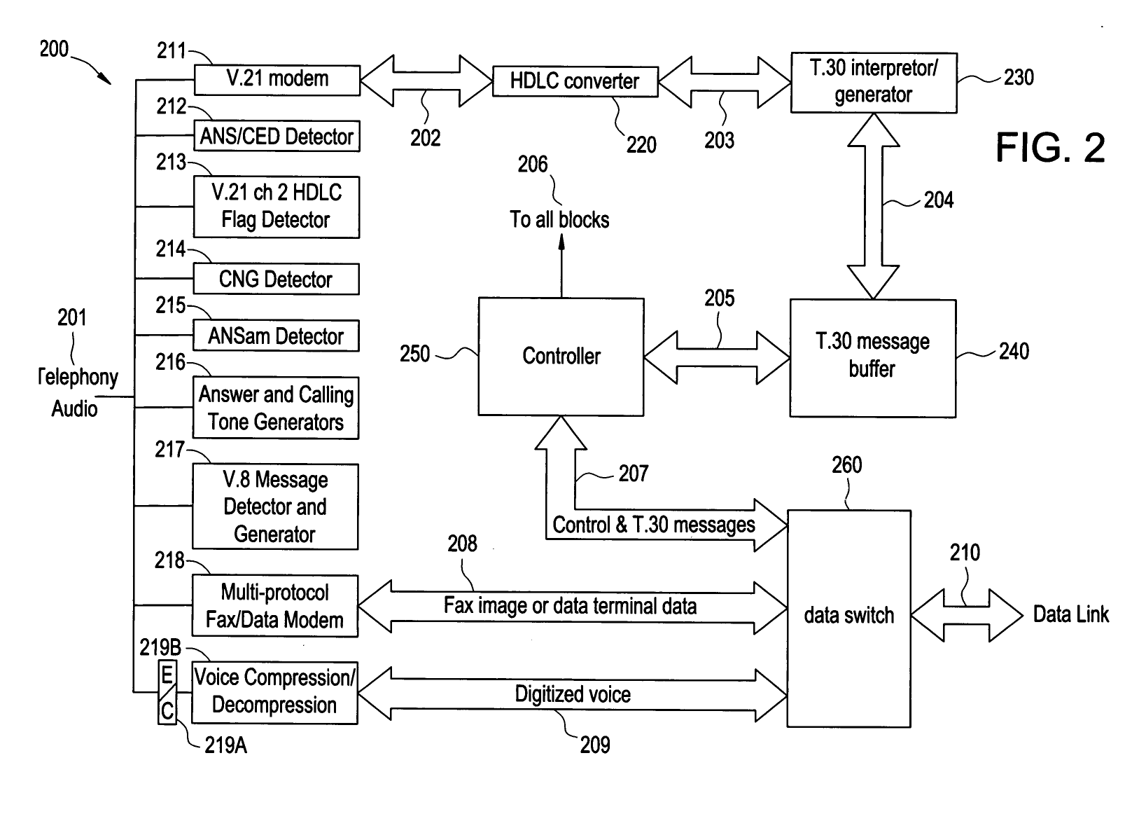

FIG. 2 is a block diagram of a communication terminal 200 that may be employed in an illustrative implementation of the subject invention. Terminal 200 is an exemplary embodiment of terminals 103 or 104 of FIG. 1. In initiating and implementing a call, whether to transmit voice, fax and/or data, a communication from the calling or called UNIT 1 or UNIT 2, telephony control and information signaling is received and an output is provided on line 201, which is coupled to several blocks that form the terminal T1 or T2. Blocks 211-217 are adapted for generation or detection of signaling to or from the terminal. Block 218 is a multi-protocol fax/data modem that can provide fax image or data onto a communication path 208. The modem 218 may implement many of the numerous data and fax modem standards used around the world, including V.34, V, FC, V.32 bis, V.32, V.22 bis, V.22A, V.22B, V.23, V.21 V.29, V.27^{ter}, V.23, Bell 212A or Bell 103 modem, each of which complies with a particular standard, and any of which are adapted to convert digital data to a particular format that is specified by the particular standard and is suitable for transmission over an audio path such as provide by the PSTN (Public Switched Telephone Network). The communications path 208 couples to a data switch 260 and provides bi-directional data communication on link 210 that may be embodied as a long distance link 113 in FIG. 1, for example. In addition, voice compression and decompression block 219B is coupled between the telephony/audio link 201 and the data switch 260 and provides a bi-directional flow of digitized voice signals over link 209. More specifically, this block provides audio compression and decompression according to an appropriate standard or algorithm and converts between audio as a digital or analog signal and digital data. The compression function converts the analog signal into digital data that can be sent at a lower data rate or bandwidth than would be required for the uncompressed audio. The decompression function converts compressed data back to an audio representation. In an exemplary embodiment, an echo canceller 219A would be disposed between the link 201 and the compression/decompression block 219B.

Returning to blocks 211-217, the V.21 Modem 211 uses methods described by ITU-T Recommendation V.21 with respect to the modulation methods and data rates. Block 211 is coupled to HDLC Converter 220 over bi-directional data link 202 and is adapted to convert data between the format commonly referred to as HDLC and a format suitable for other functions. The HDLC format is described in many places, including ISO standard ISO/IEC 13239:2002. In the terminal illustrated in FIG. 2, the HDLC converter is coupled by bi-directional data link 203 to a T.30 interpreter/generator 230. The T.30 generator 230 implements a function that recognizes and interprets T.30 messages from received data, and generates data that represents T.30 messages. The interpretor/generator 230 is coupled via bi-directional link 204 to a T.30 message buffer that operates to hold messages for access by a controller 250. The controller couples to all of the blocks by link 206 and controls their operation and reads their status for use in making decisions. The controller is where the algorithms that embody the various features of the present invention are implemented. An exemplary implementation would be a microprocessor with an appropriate control program.

Also coupled to the telephony-audio link 201 is an ANS/CED tone detector 212 that receives tones that may be transmitted from another terminal via the data link 210, data switch 260 and the controller 250. The ANS/CED tone detector 212 is capable of detecting ANS and CED signals and discriminating between the two. ANS and CED signals are described in ITU-T Recommendations G.165 and T.30 respectively.

Another detector that is coupled to the audio link 201 is the V.21 ch2 Flag Detector block 213. This detector is embodied in a demodulator portion of a V.21 Modem 211. More specifically, the block serves to demodulate for the “channel 2” variation of the V.21 signal and a HDLC flag signal detector that operates on the demodulated data.

The CNG Tone detector block 214 that is adapted to detect the T.30 CNG signal. The detector will indicate to other functions whether or not the signal is present or not present at any particular time.

The ANSam Detector block 215 is adapted to detect a tone that indicates to the relay system that a fax or data session is about to be initiated. According to the V.8 protocol, the answer or ANSam signal is typically sent to the calling terminal by a called terminal.

The answer and calling tone generator block 216 includes a CED Tone Generator and a CNG Tone Generator. The CED tone generator and CNG tone generators are operative to generate the T.30 CED and T.30 CNG tones, respectively, as instructed by other functions.

The digitized voice, fax image data and control and T.30 messages are handled by the data switch 260 for transmission to and reception over the long distance link 113. The data switch 260 will select the data being transferred between the data link 210 (which represents the external world or transmission channel) and internal functions of the device. In the current exemplary embodiment only one type of data may be sent to and from the data link 210 at any time.

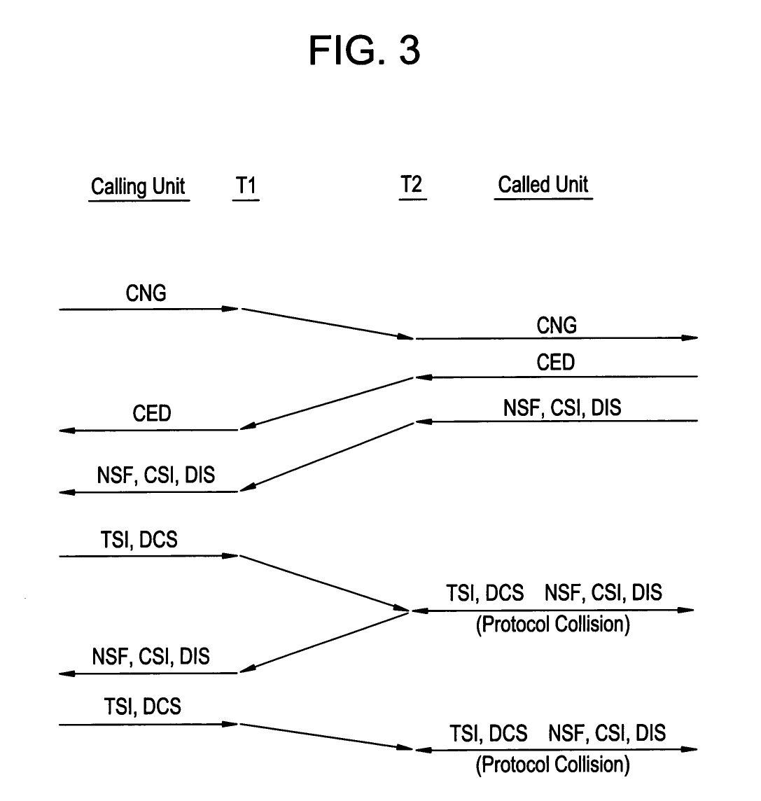

FIG. 3 is a time-line depiction of protocol interactions between a calling fax unit (USER1) and a called fax unit (USER2) through the exemplary network of FIG. 1. In FIG. 3, the present invention is not used. The Figure illustrates several signals (CNG, CED, NSF, CSI, and TSI) that are all optional signals used for a variety of purposes, including internetworking, according to ITU Standard T.30. Details on the T.30 signals are provided in ITU-T Recommendation T.30 “Procedures for Document Facsimile Transmission in the General Switched Telephone Network.” These signals are generated by some terminals, and form the basis for certain problems and require the methods of the present invention to solve such problems. The problems arise due to the significant delay that is encountered where there is path latency or demodulation/remodulation processing in order to transmit fax signals over digitally compressed audio channels.

In connection with a conventional approach to internetworking between two facsimile terminals in a system as illustrated in FIG. 1, the facsimile call attempt excerpt illustrated in FIG. 3 begins with the CNG message from the calling unit 101 (UNIT 1), which is a fax terminal. The calling unit 101 initially transfers a CNG message, typically through an optional network 105 (NET1), to a first communication terminal 103 (T1). Terminal T1 transfers the CNG message across the communication link 113 to a second communication terminal 104 (T2). In a typical arrangement, it may be assumed that the communication link 113 has a long delay. The extent of such delay is conventionally represented by the angle of the CNG arrow that is directed downward in the illustration. The CNG message is transferred to the called unit 102 (UNIT2), which may be a fax unit, data unit or the like. If a fax unit, as in the present example, it will respond with a CED message, followed by a message comprising a combination of NSF, CSI and DIS signals that serve to support internetworking between the two fax units 101 and 102. For purposes of this explanation, the combination of these signals from the called terminal to the calling terminal are referred to as the “first internetworking message.” All the signals in the internetworking message are transferred through the long delay link 113, and forwarded on to the first fax unit 101 (UNIT1). UNIT1 responds with TSI and DCS signals in this example, which may be referred to as the “second internetworking message.”

However, due to the delay of their transmittal over the communication link 113, whether because of latency or demodulation/remodulation processing, UNIT2 may time out on its original first internetworking message transmission of NSF, CSI, DCS signals, based on the programming of the ITU recommendations adopted by UNIT 2. Thus, UNIT 2, processed to consider the failure to receive the second internetworking message transmission as a loss of its original communication of the first internetworking message, will start a new transmission of the same signals that comprise the first internetworking message, resulting in a protocol collision.

Depending on the conventional protocol that is adopted at UNIT2, the fax terminal will hang up immediately upon the protocol collision, or the fax terminal will attempt to send the first internetworking message (here, signals NSF,CSI, DIS) a total of 3 times before aborting the call. An abortion of a call, which may be under any of a variety of programmed circumstances, is shown in FIG. 3. Many of these terminals also interpret the timeout between sending the first internetworking message (signals NSF, CSI, DCS) and receiving the second internetworking message (signals TSI, DCS) as starting with the first byte of signal NSF and ending after the last byte of signal DCS. That is why the transmitting terminal 103 may start repeating the first internetworking message (signal NSF, CSI, DCS) transmissions, while the communications terminal 104 (T2) is sending the second internetworking message (signals TSI, DCS) response.

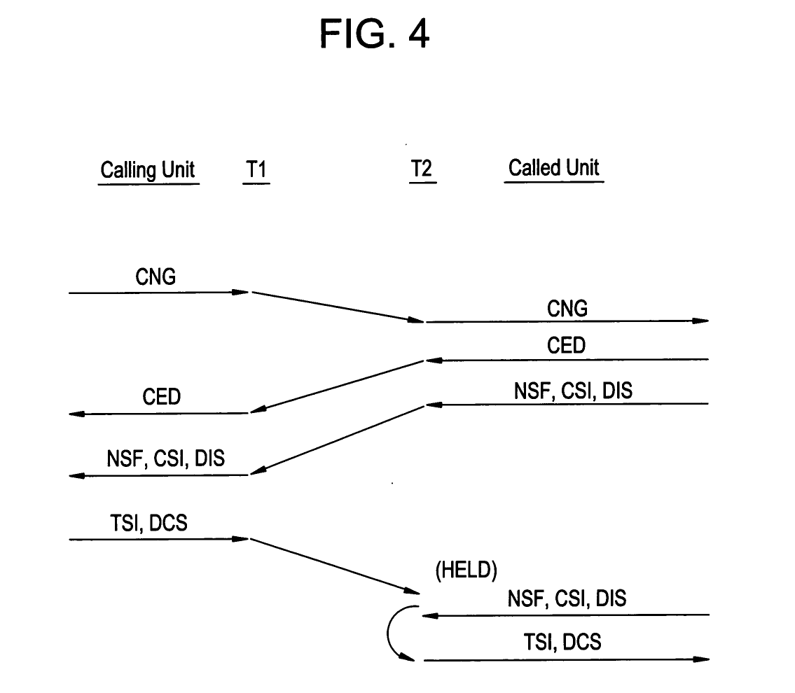

A first exemplary embodiment of the present invention is demonstrated in the time-line diagram of FIG. 4. The initiation of a facsimile call is illustrated in FIG. 4, where the call again begins with the CNG message from the calling unit 101 (UNIT1). The calling unit 101 transfers the message, possibly through the first optional network 103 (NET1), to communication terminal 103 (T1). Terminal T1 transfers the message across the communication link 113 to the second communications terminal 104 (T2). The communication link 113 has a long delay, due to latency or demodulation/.remodulation processing, which is represented by the angle of the arrow down the page. The CNG message from calling unit 101 is transferred to the called unit (UNIT2), which will respond with the CED message, followed by the first internetworking message (signals NSF, CSI and DIS) in accordance with the T30 standard. All of these signals are transferred through the long delay link 113, and forwarded on to the calling unit 101 (UNIT1). Since UNIT1 is a fax machine, it responds with the second internetworking message (signals TSI and DCS in this example). However, due to the delay of their transmittal over the communication link, the fax machine at USER2 has timed out with respect to its original first internetworking message (signals NSF, CSI, DCS) transmission and has started a new transmission of the first internetworking message in accordance with the T30 protocol. The returning second internetworking message (signals TSI, DCS), however, have not been transferred to the called fax machine at UNIT2, thus preventing the protocol collision in the conventional arrangement of FIG. 3. When T2 detects its second reception of the first internetworking message (signals NSF, CSI, DIS), it then sends the second internetworking message (signals TSI, DCS) to the fax machine at UNIT2, thus completing this phase of the protocol successfully. Note that the second group of first internetworking messages (signals NSF, CSI, DIS) from UNIT2 can be discarded or optionally transmitted across the link 113.

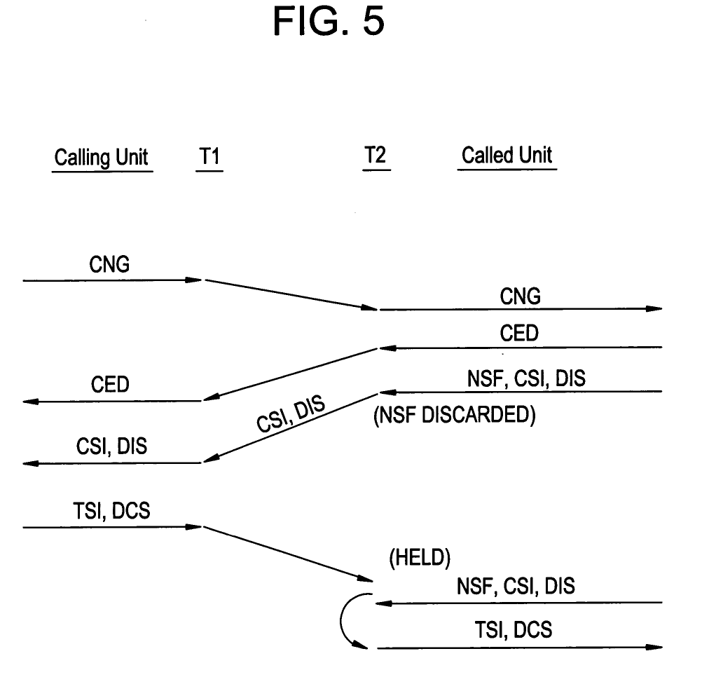

Another embodiment of the present invention is demonstrated in the time-line diagram of FIG. 5. The facsimile call attempt excerpt illustrated in FIG. 5 again begins with the CNG message from a calling fax UNIT1. It transfers the message (possibly through optional network NET1) to the first communication terminal 103 (T1). Terminal T1 transfers the message CNG across the communication link to the second communications terminal 104 (T2). This communication link 113 also has a long delay, due to latency or demodulation/remodulation processing, ass again represented by the angle of the arrow down the page. The CNG message is transferred to the called facsimile unit (UNIT2), which responds with a CED message, followed by a first internetworking message, comprising signals NSF, CSI and DIS in this exemplary example. The NSF signal is stripped away from the first internetworking message at the first terminal 103 (T1) and the remaining signals CSI,DIS are transferred through the long delay link 113, and forwarded on to the second facsimile machine at UNIT1. The NSF signal is shown in the exemplary example as being stripped at the near terminal 104 (T2), although it could equivalently be passed over the communication link 113 to the first terminal 103 (T1) where it could be stripped.

Stripping of the NSF signal before sending the first internetworking message to UNIT1 (terminal 101) results in a significant shortening of the first internetworking message, which allows UNIT1 to respond earlier with the second internetworking message.

The first facsimile machine at UNIT1 responds to the stripped message with the second internetworking message (signals TSI and DCS) in this example, but due to the delay of their transmittal over the communication link 113, the second facsimile machine at UNIT2 has timed out on its original first internetworking message (signals NSF, CSI, DCS) transmission and has started a new transmission of the signals in the first internetworking message. Since UNIT1 was able to provide the second internetworking message earlier due to the stripping of the NSF signal, the second internetworking message arrives at terminal T2 earlier, therefore negating some of the effects of the path latency and helping to ensure that the second internetworking message is ready at terminal T2 when it is needed.

The returning second internetworking message (TSI, DCS), however, has not been transferred to the called facsimile machine at UNIT2, thus preventing the protocol collision of the previous example. When the second transmission unit 104 (T2) detects its second reception of the first internetworking message (NSF, CSI, DIS), it then sends the second internetworking message (TSI, DCS) to the second facsimile machine at UNIT2, thus completing this phase of the protocol successfully. Note that the second transmission of the first internetworking message (signals NSF, CSI, DIS) can be discarded or optionally transmitted across, communication link 113, or certain signals from the first internetworking message, e.g., the NSF signal, can be discarded and the remaining signals (e.g., CSI, DIS) transmitted.

With reference back to the block diagram in FIG. 2, which illustrates an exemplary implementation of a terminal in accordance with an embodiment of the subject invention, the terminal interfaces to facsimile and/or data modems over a telephony audio interface, which may be alternatively analog or digital. In this example terminal architecture, the invention can be implemented in the controller 250. Here, the NSF signal in the first internetworking messages can be detected and discarded before being placed into the data switch for transmittal over the communication link 113. In addition, the controller 250 can be programmed to detect the returning second internetworking message (signals TSI, DCS), hold it and then forward it along when the subsequent first internetworking message (NSF, CSI, DIS) is finished.

It should be noted, however, that alternate terminal implementations could be adopted, thereby resulting in other, equivalent implementations.

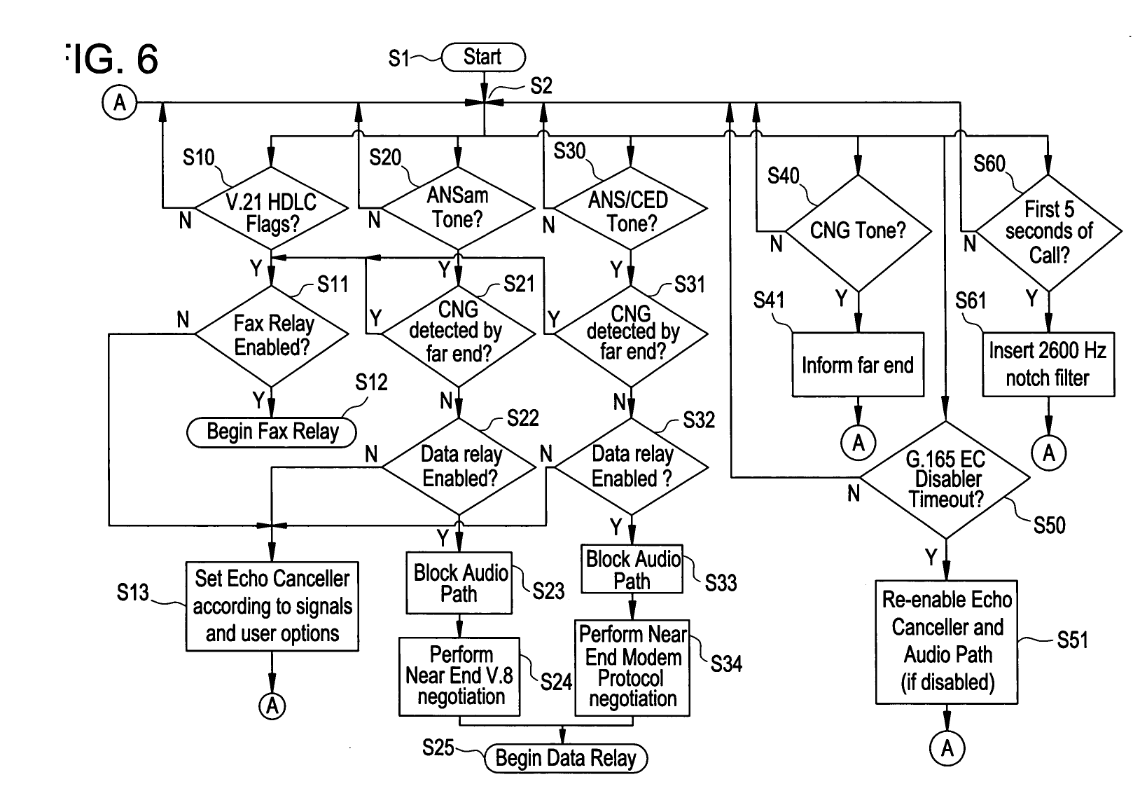

FIG. 6 present a flowchart of a second embodiment of the present invention that relates to a second aspect of the invention. The flowchart illustrates a set of six processes that are begun upon establishment of the communication link between USER 1 and USER 2 . The processes are run simultaneously in both the first terminal 103 (T1) and the second terminal 104 (T2).

An exemplary communication terminal, which is adapted to implement the second aspect of the present invention, is illustrated in FIG. 2. With the terminal as illustrated, the relay system can handle voice calls, automatic forward fax calls, manual forward and reverse fax calls, and automatic forward data calls at the maximum data rates supported by the relay system. Manual data calls may occur at data rates than the maximum allowed by the relay system. Forward calls are calls where the data or fax session is initiated in the same direction as the call setup, i.e. from calling terminal to called terminal. In reverse calls the fax or data session is initiated in the direction opposite of the call setup, i.e. from called terminal to calling terminal. Automatic calls are calls where the fax or data terminals establish a session without user intervention. Manual calls are calls where the users must take action to establish the data or fax session. In manual calls it is common for the users to first establish a voice call, converse, and then manually start their fax or data terminals as agreed during the conversation.

Several of the processes shown in FIG. 6 are required in order to allow data terminals, such as that illustrated in FIG. 2, to establish sessions at the highest possible data rates. Others allow greater accuracy in discriminating between fax and data calls. In combination the processes also allow the operators of the terminals T1 and T2 to control the relay system capabilities. This is often used to allow non-standard data terminals to use the system. The several processes begin at a START at step S1.

Following START, at step S10, the first process listens for V.21 HDLC flags, which are part of the T.30 protocol and indicate the start of a fax session. This process runs at all times, unless data or fax relay is in progress. In the exemplary implementation illustrated in FIG. 2, the detection is done by block 213 in conjunction with block 250. If V.21 HDLC flags are detected (Y), then T1 and T2 can immediately begin fax relay operation if the feature has been enabled, as determined at step S11. The fax relay operations can begin at step S12 because the ITU recommendations have been careful to avoid the use of V.21 HDLC flags in other session initiation protocols, and therefore no further discrimination is needed. This method is also used because some fax terminals do not generate other signals prior to the start of T.30 command-response sessions. If the results of the query at step S10 is N, the process reverts to the common START of the multiple process program at S2. If the results of the query at step S11 is N, an echo canceller is set according to signals and user options, at step S13. Thereafter, the program returns to the common START of the multiple process program at S2.

The second process begins at step S20 by listening for ANSam (“modified ANSwer” or “amplitude modulated ANSwer”) tones, which indicate that the answering terminal is capable of using the V.8 or V8-bis protocol for session capability negotiation in accordance with the V.8 and V.8 bis standards. Such terminal may be a data modem terminal or a fax terminal capable of operating at speeds higher than 9600 bps. In the exemplary implementation illustrated in FIG. 2, the detection is done by block 215 in conjunction with block 250. Many data modems, when operating as USER 2 of FIG. 1, require a CM response to the ANSam signal immediately, or they will not establish a data session at the highest possible data rate. Thus, this process will check at step S21 whether the other communication terminal has detected a CNG tone, and if not (N), at step S22, it will detect if data relay is enabled (Y). If data relay is enabled (Y) and a CNG tone has not been detected (N) at step S21, the process will respond with a CM message indicating the calling terminal is a data terminal and is capable of data rates up to the capability of the communication link. The audio path will be blocked at step S23 and near end V.8 negotiation will be performed at step S24 before beginning data relay at step S25. If data relay is determined not to be enabled at step S22 (N), the echo canceller is set according to signals and user options at step S13 and the process returns to the common START of the multiple process program at S2. Notably, this process runs only if a data or fax relay session is not already in progress.

If a CNG tone has been detected at step S21 (Y), then the ANSam detection process will assume the call will be a fax call and then proceed as the V.21 HDLC Flag detection process and determine whether the fax relay is enabled at step S11. If so, fax relay is begun at step S12.

The third process begins with step S30 listening for ANS/CED (ANSwer or Called Station Identification) signals, also known as G.164 Echo Suppressor Disabler signals. These signals can indicate that the terminal is either a data terminal not capable of V.8 negotiation, or a fax terminal typically operating at a data rate of 9600 bps or lower. In the exemplary implementation illustrated in FIG. 2, the detection is done by block 212 in conjunction with block 250. If no tone is detected (N), the process returns to the common START of the multiple process program at S2. As in the previous process, this process will check if the other communication terminal has detected a CNG tone at step S31 and if data relay is enabled at step S32. If data relay is enabled (Y) and a CNG tone has not been detected (N), the process will assume data relay operation and block the audio path in step S33 and respond with a series of calling tones until the relay system and the USER terminal generating the ANS signal negotiate a protocol in step S34. Data relay operation will then begin at step S25. This process does not run if a fax or data relay session is already in progress.

If either the ANSam or ANS detection processes detect a signal but find that CNG is detected by the far end at step S31 (Y), the process proceeds to determine if the fax is enabled at step S11 and then can begin fax relay at step S12.

If either the ANSam or ANS detection processes detects a signal, but finds that data relay is disabled and no CNG signal has been detected, they will disable the Echo Canceller, if one is present. This allows non-standard and low-speed data terminals to operate through the compressed voice channel. The exemplary embodiment also allows the terminal operator to configure the Echo Canceller to remain operational in step S13, which allows specific proprietary data terminals, such as are found in Pay Telephones and Point-of-Sale terminals, to internetwork via the compressed voice channel.

The fourth process begins at step S40 and listens for a T.30 CNG signal. This signal indicates a calling fax terminal. In the exemplary implementation illustrated in FIG. 2, the detection is done by block 214 in conjunction with block 250. If the signal is detected (Y), the process will inform the far end communications terminal at step S41 so that it may respond correctly if it detects the ANSam or ANS signals. If the signal is not detected, the process returns to the common start at S2.

The fifth process begins at step S50 by monitoring for conditions where the echo canceller and normal audio path should be re-enabled at step S51. Such conditions may occur after a voice channel (non-relay) fax or data session has completed and the users wish to continue the call with voice communications. These conditions may also occur after a fax or data relay session has completed, or after false detection or “talk-off” by the ANSam or ANS signal detectors.

The sixth process begins at step S60 by determining whether the program is within the first five seconds of a call and inserting a 2600 Hz notch filter into the audio path during the first five seconds of the cal at step S61. This filters out ANSam and ANS signals from the audio path and is done in order to allow some of the data modems on the market to negotiate with the relay system at the highest data rate possible. Experience has shown that, if the ANSam or ANS signal is allowed to pass through the audio channel before data relay begins, then a calling data modem will fall back to a lower data rate during the negotiation at the start of data relay. The filter is inserted only during the first five seconds in order to be effective for automatic data calls and yet not interfere with voice conversations. Once the first 5 seconds have passed, the program returns to the common start at S2.

Again, with reference to FIG. 2, which is a block diagram of an exemplary implementation of a terminal in accordance with an embodiment of the subject invention, the terminal interfaces to facsimile and/or data modems over a telephony audio interface, which may be alternatively analog or digital. Again, the invention can be implemented in the block labeled Controller. Here, the decisions required by the flowchart in FIG. 6 can be made. Note, however, that alternate terminal implementations can result in other, equivalent implementations.

While the foregoing description is directed to certain exemplary embodiments, the invention disclosed herein is not limited thereto, but is to be defined by the appended claims.

What is claimed is:

1. A method of establishing internetworking between first and second fax units operative to communicate via respective first and second terminals that are coupled by a communications link, comprising:
at said first fax unit, initiating a communication by transmitting via said first terminal an initiation signal over said communication link to said second fax unit via said second terminal;
at said second fax unit, receiving and responding to said initiation signal by transmitting via said second terminal at least a first internetworking message comprising a plurality of signals, said second fax unit being operative to periodically retransmit said first internetworking message under predetermined conditions, including a delay of a first predetermined period of time;
at said first fax unit, receiving and responding to said first internetworking message by returning a second internetworking message to said second fax unit via said first terminal and said second terminal; and
at said second terminal, delaying a retransmission of said first internetworking signal for a second predetermined period of time greater than said first predetermined period of time, awaiting receipt of said second internetworking message.

2. The method of claim 1, wherein at least one of the plurality of signals in said first internetworking message is discarded at a terminal between transmission from said second fax unit to said first fax unit.

3. The method of claim 1, further comprising, at said second terminal, following a delay of retransmission of said first internetworking message, upon reception of said second internetworking message, discarding said delayed first internetworking signal.

4. The method of claim 1, further comprising, at said second terminal, following a delay of retransmission of said first internetworking message, upon reception of said second internetworking message, transmitting said delayed first internetworking signal.

5. The method of claim 1, wherein communication between said first and second fax units is according to the ITU T.30 protocol.

6. A system having a first transmitting terminal and a second transmitting terminal operative to communicate via a communications link susceptible to delay, sad system comprising:
a first fax unit coupled to said first terminal and a second fax unit coupled to said second terminal, wherein
said first fax unit is operative to initiate a communication by transmitting via said first terminal an initiation signal over said communication link to said second fax unit via said second terminal, and said second fax unit is operative to receive and respond to said initiation signal by transmitting via said second terminal at least a first internetworking message comprising a plurality of signals, said second fax unit being operative to periodically retransmit said first internetworking message under predetermined conditions, including a delay of a first predetermined period of time;
said first fax unit, is operative to receive and respond to said first internetworking message by returning a second internetworking message to said second fax unit via said first terminal and said second terminal; and
said second terminal is operative to delay a retransmission of said first internetworking signal for a second predetermined period of time greater than said first predetermined period of time, awaiting receipt of said second internetworking message.

7. The system of claim 6, wherein at least one of said first terminal and said second terminal is operative to discard at least one of the plurality of signals in said first internetworking message.

8. The system of claim 6, wherein, said second terminal, following a delay of retransmission of said first internetworking message, upon reception of said second internetworking message, is operative to discard said delayed first internetworking signal.

9. The system of claim 6, wherein, said second terminal, following a delay of retransmission of said first internetworking message, upon reception of said second internetworking message, is operative to transmit said delayed first internetworking signal.

10. The system of claim 6, wherein communication between said first and second fax units is according to the ITU T.30 protocol.

11. A method of managing a relay communication between a calling terminal and a called terminal, comprising:
establishing of a communication link between the calling terminal and the called terminal;
establishing a plurality of processes at each of said calling terminal and called terminal for determining at least one of (a) whether there is a presence of a signal indicating a start of a fax session, (b) whether there is a presence of a tone indicating a calling terminal is a fax terminal and a called terminal is capable of using a protocol for session capability negotiation and whether a data relay is enabled, (c) whether there is a presence of a tone indicating a calling terminal is a fax terminal that is operating at a data rate below a predetermined threshold and whether a data relay is enabled, and (d) whether there is a presence of a signal indicating a calling terminal is a fax terminal,
inserting a filter for a limited period to filter out signals from the audio path to allow data modems to negotiate with the relay system at the highest possible data rate; and
monitoring conditions to determine whether an echo canceller and normal audio path should be reestablished.

12. The method of claim 11 further comprising beginning a fax relay if a signal is present indicating a start of a fax session and fax relay is enabled.

13. The method of claim 12, wherein the signal is a V.21 HDLC flag within the T.30 protocol.

14. The method of claim 11 further comprising beginning a fax relay if a tone from a called terminal is present indicating a fax terminal is operating at a data rate below a predetermined threshold, and fax relay is enabled.

15. The method of claim 14 wherein the tone comprises an ANS/CED tone within the T.30 protocol.

16. The method of claim 11 further comprising beginning a data relay if a tone from a called terminal is present indicating the called terminal is capable of using a predetermined protocol for session capability negotiation, no signal is detected at a called terminal indicating a calling terminal is a fax terminal, and data relay is enabled.

17. The method of claim 16 wherein the tone is an ANSam tone within the V.8 protocol.

18. The method of claim 16, wherein the tone is an CED tone within the T.30 protocol or a ANS tone within the various data protocols.

19. The method of claim 17, further comprising the performance of near end V.8 negotiation.

20. The method of claim 18, further comprising the performance of near end modem protocol negotiation.

21. The method of claim 11, wherein said monitoring step comprises determining whether there is a G.165 echo canceller disabler time out.
